(19) United States
(12) Patent Application Publication
(10) Pub. No.: US 2005/0023020 A1
(43) Pub. Date: Feb. 3, 2005

(54) Cover plates for ADSL-splitter positions in modular distribution frames

(76) Inventor: Friedrich Denter, Castrop-Rauxel (DE)

Correspondence Address: 3M INNOVATIVE PROPERTIES COMPANY, PO BOX 33427, ST. PAUL, MN, 55133-3427, US

(21) Appl. No.: 10/444,147

(22) Filed: May 22, 2003

Related U.S. Application Data
(60) Provisional application No. 60/383,185, filed on May 23, 2002.

(51) Int. Cl. H02G 3/08

(52) U.S. Cl. 174/50

(57) ABSTRACT

A device for the covering of the position of the module within the modular distribution frame is provided. The device comprises a covering unit that can be placed onto the position. The module is designed that it can be arranged side-by-side with other modules on the frame-body and the construction of the module allows the introduction of the wires with their wire ends, which are intended to be connected to the module. The covering unit as such is designed so that it provides protection to the wires and the wire ends and to maintain the defined positions of the wires.

This application claims priority to Provisional Application No. 60/383,185 filed May 23, 2002.

### TECHNICAL FIELD

The invention relates to a device for covering a position for a module in a modular distribution frame that is typically used in telecommunication central office arrangements. The invention is further related to a method for providing of a module position in a modular distribution frame intended to be retrofit with a passive or active component, such as an XDSL-splitter.

### BACKGROUND OF THE INVENTION

Modular distribution frames, especially for telecommunications central office arrangements, are typically used to install, control and modify the wiring that, on one side, is guided to the central office from the subscriber and which goes, on the other side, to switching units, other electronic equipment such as control devices and to further central offices. The incoming wires, typically from the subscribers, and the outgoing wires have to be connected. This is generally done in modular distribution frames (MDF), which is generally achieved through the use of different types of terminal blocks. Terminal blocks are typically arranged side-by-side on frame bodies of the modular distribution frame. In the past, these terminal blocks established the direct connections, and the incoming wires were connected to them through well-known methods such as insulation displacement connectors, wire-wrap, and the like, while older methods such as soldering or screw-type connectors were practically outdated.

It has become increasingly necessary to expand the function in the modular distribution frames by adding additional components. It is common now to have so-called disconnection modules, which allow the incoming and the outgoing wires to be disconnected from each other by inserting a corresponding plug, which is of importance when, for example, line testing is necessary. Furthermore, other components are more frequently used, such as those that protect against high voltage or high current overloads, and other electronic equipment that could for example be used for the testing of telephone lines.

More recently, it became common to further integrate into such a MDF an asymmetric digital subscriber line (ADSL) or XDSL splitter, which allow the separation of the telephone signals from high data rate signals carried on the same line. ADSL-splitters separate the telephone signal (which is guided to the telephone system as plain old telephone services, or POTS) from the high data rate signals that typically are guided to a D-SLAM or other electronic component that is capable of handling the high data rate signals.

It has become increasingly common to install these splitters in the central office in order to be prepared to provide DSL service to the highest possible number of subscribers. On the other hand, the widespread installation of ADSL- or XDSL-splitters and similar components costs a significant amount of money, which made it necessary to consider how to retrofit these components into existing MDFs instead, and how to prepare MDFs for such a retrofit.

Therefore, solutions have been identified to guide the incoming and outgoing wires onto the modular distribution frames and to connect them in some way to connection points or to introduce sockets or printed circuit boards with such sockets onto which the components such as a XDSL- or ADSL-splitter can be inserted.

### SUMMARY OF THE INVENTION

In one embodiment, the present invention eliminates the step of connecting the incoming and outgoing wires to any kind of connectors, such as those arranged in terminal blocks or connection modules. The wires are installed in a manner that one of their ends is installed in the usual manner at the next unit, while, within the modular distribution frame, the other ends are left unconnected. In order to allow a connection at a later stage, the wire-ends are provided with an excess length. Under current practice, wires were first installed and then subsequently connected to the terminal blocks or connection modules. During the connection process the excess length was cut off, either within the module itself or through a special tool. The invention recognizes the value in leaving the ends of the wires in the modular distribution frame. This is established for at least one pre-selected position for a module. In order to achieve this, a device for the covering of the position of the module within the modular distribution frame, having a frame-body is used. The device comprises a covering unit that can be placed onto the position. The module is designed that it can be arranged side-by-side with other modules on the frame-body and the construction of the module allows the introduction of the wires with their wire ends, which are intended to be connected to the module. The covering unit as such is designed so that it provides protection to the wires and the wire ends and to maintain the defined positions of the wires.

In one group of modules, housings are used into which components can be inserted, such as terminal blocks or passive or active components, such as ADSL- or XDSL-splitters. These housings typically contain wire guidance systems. Preferably, the wires are guided through channel systems which are placed on the sides of the housings of the modules.

In a preferred configuration, the covering unit that is the subject of the invention comprises devices for the positioning and the affixation of the wires and the wire ends. This can preferably be achieved by having a plate integrated into the covering unit, which is arranged so that upon placing the covering unit onto the position for the module, the plate projects into the housing of the module. The plate can be provided with holes and other projections, so that the wires can be passed through the holes and fixed onto the projections in a manner that this is done in a well-defined way so that the positioning and fixing of each individual wire is identified. In order to facilitate the identification, it is a preferred method to provide the covering unit with an indicator for the identification of the wires.

As an alternative, the covering unit has essentially the form of a lid, which is fixed onto the module housing. In this case, the wires and the wire ends are not fixed onto projections or the like, but simply placed within the module housing. This may be advantageous, if the number of wires is relatively small or their length is relatively short so that a lack of a special projection or the like would not create a problem when retro-fitting the system, as long as defined positionings of the wires are obtained.

Furthermore, the covering unit can be provided with snapping device which, upon the placement of the covering unit onto the module housing, the covering device snaps directly onto it, thus providing the necessary protection for the wires and simultaneously providing a defined positioning of the wire-ends.

In another group of devices, it is common to mount the terminal blocks directly onto the frame-body of the modular distribution frame. In this case, it is preferable to leave the desired position to be retrofit open and to attach a specially designed covering unit, which preferably is provided with devices for the positioning and fixing of the wires and wire-ends and snapping devices, which allows the covering unit to directly snap onto the frame-body. In some cases, the passive or active components to be introduced into the housing module may have provisions where at least some of the wires are brought in connection with the component through the use of plugs. This can for example be of interest in the case that specific configurations of ADSL- or XDSL-Splitters are used. In such a case, the wire ends are already connected to plugs. These plugs can either allow a connection to a single wire or to a multiplicity of wires. Furthermore, the plugs are typically provided with receptacles or pins, which are designed so that they can engage with the corresponding pins or receptacles of the active or passive components. These receptacles or pins can be arranged on the lateral side of the plugs, so that between the pins or receptacles of the active or passive components and the wire an angle of about 90 degrees is obtained, or they can be arranged at the distal ends of the plugs. The application of these plugs then typically ensures a clear positioning of the individual wires and wire ends. Therefore, the configuration is particularly advantageous when the covering unit consists of a lid only.

The invention further provides a method for the generation of a module position in a telecommunication modular distribution frame, the position being intended to be retrofit with a passive or active component. The method comprising the steps of

arranging a multiplicity of modules with housings on the frame-body of a modular distribution frame, the housings allowing to introduce wires having wire-ends that are intended to be connected to the passive or active component to be introduced into the modules,

in at least one of the module housings inserting a multiplicity of wire-ends that are intended to be connected to the passive or active component to be introduced into the module, and

arranging of the wire-ends within the modules in pre-defined positions allowing the maintenance of defined positions of the wires and their connection to the passive or active component.

It would be the most straightforward way to introduce the wires into the modules and leave the ends within the openings of the housing. In a more preferred mode, the method further comprises the step of placing a covering unit as described above onto the housing. In a more preferred mode, it is possible to fix the wires onto the covering unit by positioning and affixation devices described above.

Alternatively, at least some of the wire ends may be connected to plugs that may be connected to the active or passive component.

The same method can also be used for the alternative group of modules, where in a preferred mode, the covering unit is directly placed onto the frame-body of the modular distribution frame.

When it is desired to retrofit the position with an active or passive component like an ADSL- or XDSL-splitter, an electronic component for testing or any other electronic unit, it is simply possible to remove the covering unit, which, in a preferred configuration, is snapped onto the module or the frame-body and to pull the covering unit out of the modular distribution frame, so that the individual wires can be moved out. The component to be installed is then inserted into the opening of the housing or directly onto the frame-body of the modular distribution frame and subsequently the wires are connected to it in the usual manner by either removing them individually from the affixation devices of the covering unit or if the length is sufficiently large, to leave them on the covering unit and to establish the connection directly, subsequently cutting the excess length off. When this is done with all wires, the covering unit, eventually together with the excess lengths of the wires, can then be simply be removed and either discarded or re-used for another installation.

### BRIEF DESCRIPTION OF THE DRAWINGS

The present invention will be described with reference to the attached Figures, in which:

FIG. 1 shows a side-by-side arrangement of empty module housings on a modular distribution frame;

FIG. 2 is a single module housing into which a terminal block in the form of a disconnection module is inserted;

FIG. 3 is an arrangement similar to FIG. 2, whereby an ADSL-splitter is inserted;

FIG. 4 is a cross-sectional view of a module housing with wire guidance channels on both sides according to the method of the invention, showing an installed wire with its wire end;

FIG. 5 is a configuration similar to FIG. 4 in which the top of the module housing is covered with a covering unit;

FIG. 6 is a configuration similar to FIG. 5, but without any wire guidance systems on the sides;

FIG. 7 shows an exploded view of a module housing, a covering unit with a plate with affixation devices and an additional system for the identification of the wires;

FIG. 8 is a configuration according to FIG. 7, but with an installation of four wires connected to the covering unit;

FIG. 9 shows a cross-sectional view of corresponding to FIG. 8, after having the covering unit closed and snapped onto the module housing; and

FIG. 10 shows an alternative embodiment of a modular distribution system with a terminal block and a covering unit, adjacent to it the covering unit being installed with four wires and their wire ends.

FIG. 11 shows an embodiment similar to the configuration shown in FIG. 5, where, however, the wire end is connected to a plug.

FIG. 12 shows and embodiment similar to FIG. 8, where, however, the wire end is connected to a plug.

### DETAILED DESCRIPTION OF THE INVENTION

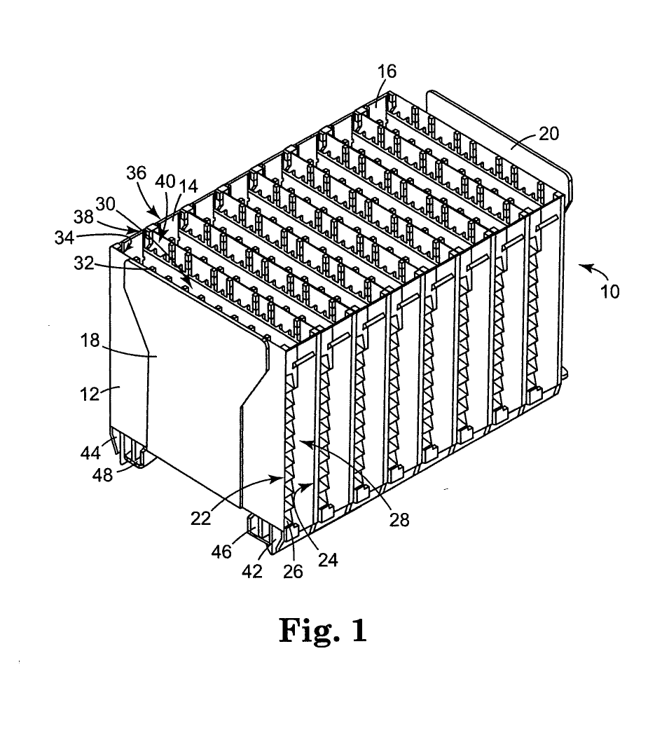

In one group of modules that are mounted onto modular distribution frames, module housings are used, which are at least open and accessible from the side onto which the connections of the wires are made and which typically also include wire guidance systems. One type of these configurations is shown in FIG. 1, where a side-by-side arrangement 10 of module housings 12, 14 up to 16 is shown. The group of in this case 8 module housings is held together with a U-shaped plate arrangement, the sides 18, 20 of is which can be seen. The details of the individual module housings are only referred to with respect to housing 12. The two sides 22, 24 include wire guidance systems, which are well known in the art. The left wire guidance system 22 includes openings 26 on the left side 28 of the module housing 12, which are curved at an angle of about 90 degrees, and the guidance channels reach to the top 30 of the module housing 12 with the rips 32 forming the channel ends 34. Each individual wire is inserted into one of the entrance openings 26 and leaves the channel through an exit opening 34. Accordingly the longest channel among those shown in FIG. 1 is the one where the wire enters at the lowest position 26 on the left side 28 and leaves at the farthest left opening 34 on the top side 30. While the right side 28 of the module housing 12 is open, the corresponding left side 36 is closed with a corresponding wall. The module housing 12 is provided with a second wire guidance channel system 24, where the entrance portions 38 are not visible, while the exit portions 40 can be directly seen.

The module housings 12, 14 up to 16 are further provided on their lower end with snapping devices 42, 44, which snap directly onto rails 46, 48, which form a part of the modular distribution system. The details of these rails are not shown. They form an integral part of a mechanical support system, as is well-known in the art.

The module housings described above, and especially the wire guidance channel systems, are only one example of wire guidance systems provided in or on the housings. Other arrangements are also possible, and accordingly the invention is not limited to the specific configuration shown in FIG. 1.

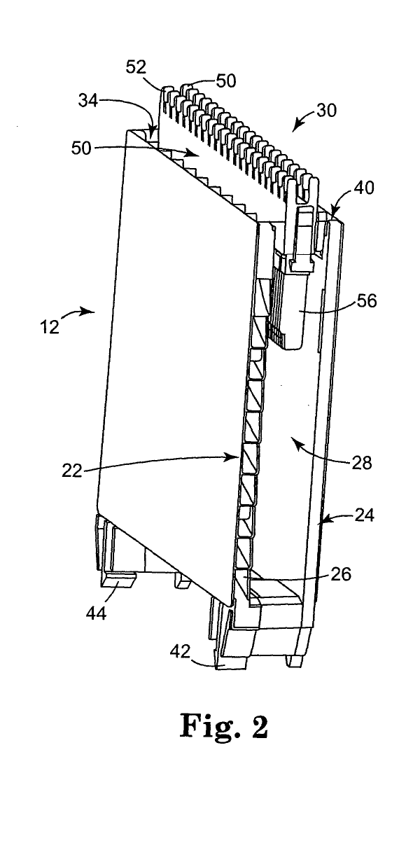

FIG. 2 shows a single module housing, corresponding to module housing 12 in FIG. 1. Wire guidance systems 22, 24 are shown, the left one 22 with the openings 26 on the left side 28 of module housing 12 and the exit opening 34 on the upper opening 30. Likewise, on the right wire guidance channel system 24, one upper opening 40 can be seen. Furthermore, the snapping components 44, 42 on the lower side of module housing 12 can be seen without any modular distribution frame onto which it is supposed to be attached.

A terminal block 50 in form of a disconnection module has been inserted into the upper opening 30 of module housing 12. The details of this terminal block are generally known and therefore not referred to in detail. They typically contain two rows 52, 54 of connection units which in this case are insulation displacement contacts. The terminal block contains an area 56 projecting into the opening 30 of housing module 12, which, for example, can contain disconnection contacts. This means that the connection between corresponding contacts in the rows 52, 54 can be disconnected by placing a plastic plug between the rows as it is generally known. In a typical application, wires are inserted into the wire guidance channel system, entering in the entrance opening 26 on the side 28, exiting on the opening 34 on the side 30, being connected to the contact in the contact row 52 with an appropriate tool. Typically the excess length of the wire is cut off either in the contact itself or through a special tool.

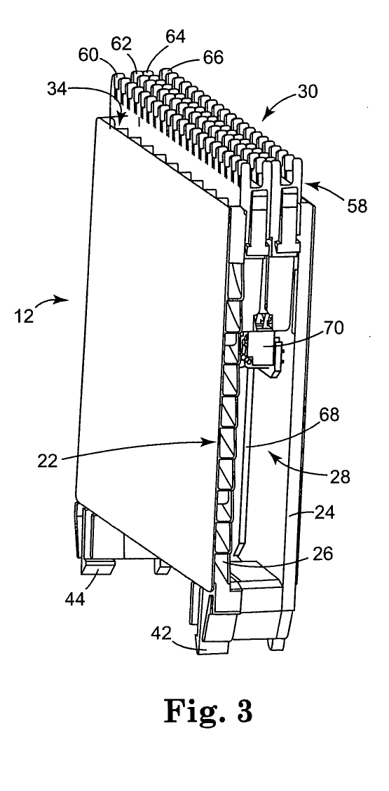

FIG. 3 essentially corresponds to FIG. 2, however, instead of a conventional terminal block or disconnection module, a more sophisticated electronic component, such as an ADSL- or XDSL-splitter is inserted. Also in this case, the housing module 12 has the left wire guidance channel system 22 with an entrance opening 26 and exit opening 34 and a right wire guidance channel system 24. The module housing 12 is also provided with snapping devices 42, 44. Into the upper opening 30 of housing module 12, the ADSL-splitter system 58 has been inserted in the same manner as the terminal block 50 in FIG. 2. The ADSL- or XDSL-splitter is provided with four rows 60, 62, 64, 66 of contacts onto which the different wires can be connected, such as the wires coming from the subscriber side, the ones that proceed to the switching unit or the next central office system (POTS) and the wires that are supposed to go to the D-SLAM or a similar electronic unit that is capable of handling high data rate signals. The details of such an ADSL-splitter are described in documents including DE 201 04 605, the contents of which is incorporated by reference herein, but which describes a system that also incorporates two wire guidance channel systems. In this case the ADSL-splitter is provided without such a system because it is inserted into the module housing 12, which in itself contains the wire guidance systems 22, 24. The ADSL-splitter is provided with a printed circuit board, which contains the splitter components that can be either active or passive electronic circuitries. The printed circuit board is connected by devices 70 (not shown in detail) to the contacts rows 60, 62, 64, 66. FIGS. 2 and 3 are supposed to demonstrate the way in which any suitable kind of component can be inserted into the module housing 12, such as devices that protect against high voltage or high current, or that provide electronic circuitry for testing or other applications.

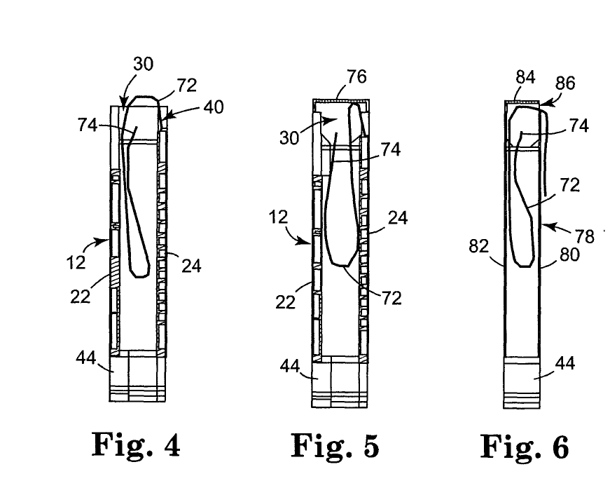

FIG. 4 shows a step in a process according to the present invention. It is a cross-sectional view of module housing 12, which again is provided with wire guidance channel systems 22, 24 and snapping devices 44 for the mounting onto a modular distribution frame. A single wire 72 with the wire end 74 is depicted, which, according to the invention, is inserted into the right wire guidance channel system, the entrance of the wire not being shown. According to the invention, the wire is left in the opening of module housing 12, preferably entirely placed within the housing. In this particular case, it can be seen that a small portion protrudes from the opening 30 of module housing 12. Under normal circumstances, a multiplicity of wires, for example four or ten wires or wire-pairs are inserted and placed side-by-side, which is facilitated due to the fact that the wires 72 project from the upper openings 40 of the wire guidance channel system 24. Therefore, it is possible to identify the wires rather easily without the need to fix them when being placed into the inner part of the module housing 12, preferably below the opening 30.

FIG. 5 shows a further development, using the same reference numerals. One difference is that the upper opening 30 is covered with covering unit 76, which in this embodiment essentially has the form of a lid, which is affixed onto the module housing 12, preferably by some kind of a snapping mechanism as will be described below. However, any other type of affixation system is possible, and the module housing 12 may be provided with protrusions into which the housing snaps in or with upper portions that enable the covering unit 76 to press-fit onto the upper portions of the module housing 12. Also, in this case a single wire is shown. However, under normal circumstances a number of wires are used, each similar to the configuration as depicted in FIG. 4.

FIG. 6 shows an alternative embodiment that does not contain any wire guidance channel systems. It consists of the module housing 78, which is provided with flat walls 80, 82. The housing is designed for a side-by-side arrangement, with a separation between adjacent walls, namely the right wall 80 of one module housing 78 is adjacent to the left wall 82 of the adjacent corresponding module housing 78. This allows wires to be guided between two adjacent housings (not depicted). Also here only a single wire 72 with its end 74 is depicted, although in general several wires will be used. Furthermore, it can be seen that the covering unit is different. It leaves an opening side 86 into which the wires can be inserted. FIG. 6 demonstrates the principle in general; specific design details can be determined based on the particular application.

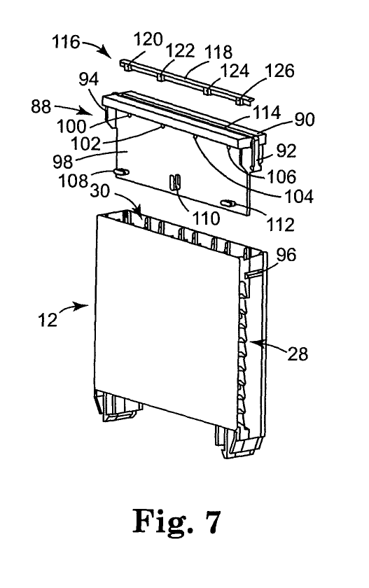

FIGS. 7, 8, and 9 show a further developed unit, which not only provides a cover opening 30 of a module housing 12, but simultaneously also provides the possibility to position and fix the wires 72 with the wire ends 74, so that they are maintained in a pre-determined position, so that they can be easily identified when removing the covering device and when establishing a connection to a passive or active component to be inserted into the module housing 12. FIG. 7 shows the module housing 12 with its openings 28, 30 and in an exploded view two parts of an exemplary covering unit, which in principle corresponds to the covering units 76, 84 of FIGS. 4 through 6. The covering unit 88 itself consists of a main cover plate 90 and is provided on both sides with snapping devices 92, 94, which interact with groove 96 (only visible on one side) of module housing 12. Onto the main cover plate 90 is attached a wiring plate 98, the purpose of which is to allow a positioning and fixing of the wires in a defined manner. It is provided with four holes 100, 102, 104, 106, corresponding to four wires that are supposed to be sorted. The number, however, can vary, for example it is possible to also introduce wires from each side from the two different wire guidance channels or it is possible to supply plate 98 with a higher number of holes, such as 10 or 20 holes. The plate 98 is further provided with affixing devices 108, 110, 112, with which the wires can be affixed. These are shown as portions that protrude from plate 98, which can be executed so that the component can be molded rather easily and the distance between the holding portion of each unit 108, 110, 112, can be designed so that a wire can be clamped in. However, there are other ways of affixing the wires. Furthermore, it is possible to provide plate 98 with similar arrangements on the opposite side (not shown). In this case, the corresponding openings would be seen. The main covering plate 90 is furthermore provided with some kind of a groove 114 into which the identification indicator 116 can be inserted. This identification indicator can consist of a small plate 118 onto which markers can be placed, or space can be provided that allows one to write identification marks. The identification indicator 116 on its lower side is provided with small protrusions 120, 122, 124, 126, which allow the identification indicator 116 to be inserted into groove 114. Alternatively it is also possible to provide the marking directly onto the main cover plate 90 without any indicator.

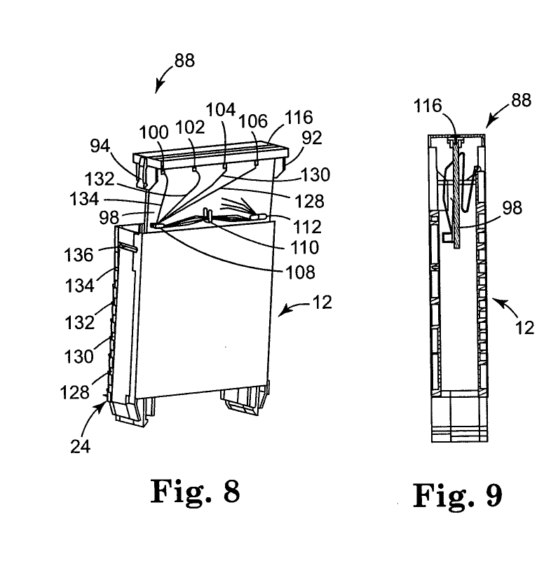

FIGS. 8 and 9 show in which way the covering unit depicted in FIG. 7 can be used for positioning and affixing the wires and the wire ends. FIG. 8 shows the affixing step prior to the placement of the covering unit 88 onto the module housing 12. Like in FIG. 7, it can be seen that the covering unit 88 is provided with the identification unit 116. It has further the two snapping portions 92, 94 and the plate 98 is provided with holes 100, 102, 104, 106 and affixing devices 108, 110, 112. For the sake of simplicity, only an arrangement with four wires is shown, coming from one of the wire guidance channel systems 24 (it should be noted that in FIG. 8 the unit is rotated, so that the other side in the openings of the wire guidance channels system 24 are visible). In this case, four wires 128, 130, 132, 134 are inserted into the respective openings of wire guidance channel guide 24. The corresponding open ends (not visible) are guided through holes 100, 102, 104, 106 and are affixed by affixing devices 108, 110, 112 of plate 98. After the completion, the covering unit 88 can be pushed onto module housing 12 until the snapping parts 92, 94 snap into the corresponding grooves 136 (only visible in FIG. 8, 96 only visible in FIG. 7). FIG. 9 shows the corresponding cross-sectional view of the same embodiment.

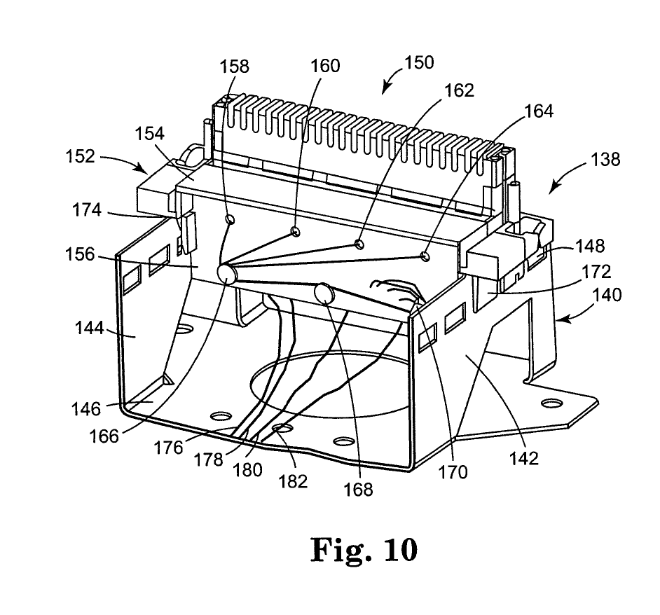

FIGS. 1-9 show a group of connection modules to be placed onto modular distribution frames, having a frame-body in which module housings are used into which passive or active components can be inserted, and which typically are provided with lateral wire guidance channel systems. The principle is also applicable to other types of modular distribution frames in which terminal blocks of different types are directly placed onto the frame-body of modular distribution frames. Accordingly, one configuration of this type is shown in FIG. 10. It shows a modular distribution frame 138 which is provided with different components. The modular distribution frame 138 has a frame-body 140, which consists of a U-shaped configuration with two side portions 142, 144 and a base portion 146. The modular distribution frame can have a different construction which is well-known in the art; it may, for example, consist of two separate side portions which are linked together on a separate frame-body. Furthermore, the side portions may be substituted by rails of some kinds or rods onto which the components to be mounted are affixed in different ways, all of which is well-known in the art.

In this particular configuration, the side portions of the frame-body are provided with rectangular openings 148, which allow one to snap on a variety of components to be assembled onto the modular distribution frame. In this particular case, a terminal block 150 is arranged on the backside. In front of it, an alternative embodiment of a covering unit 152 is placed. It is provided with a main covering plate 154 and an additional plate 156 for the guidance and affixation of the wires, which is perpendicularly arranged with respect to the main plate 154. This wire fixing plate 156 is provided with four holes, 158, 160, 162, 164 and wire affixing devices 166, 168, 170. Furthermore, the covering unit 152 is provided with snapping devices 172, 174 that can snap into any of the rectangular openings 148 of the lateral parts 142, 144 of the frame-body of the modular distribution frame 138. It should be noted that in this particular configuration no wire guidance channel systems or the like are used, due to the relatively small distance between the lower part close to the bottom plate 146 of the frame-body 140. Therefore, in a typical configuration the components are placed side-by-side and snapped onto the frame-bodies through the rectangular openings 148 in a manner that sufficient space is provided between two adjacent components so that wires can pass through them in order to be easily affixed to the individual components. In a typical configuration the wires are coming from the lower part and pass between two components to the upper part of, connecting a component such as a terminal block 150 onto which they are connected in a well-known manner.

In this particular case four wires 176, 178 180, 182 are shown, which are guided on the lower portion of the frame-body near its bottom component 146. They are then guided through holes 158, 160, 162, 164 of the plate 156 of the covering unit 152 in a manner that is in principle similar to the one shown in FIG. 8. The wires are then affixed onto the affixation devices 166, 168, 170 in a similar manner. In this case, the affixation devices have a different geometrical configuration as compared to those in FIG. 8.

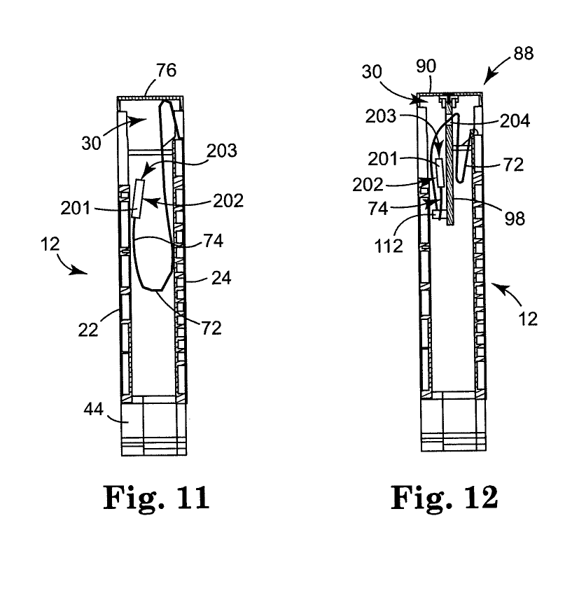

FIG. 11 shows an alternative configuration, in which the wire ends can be connected to a plug. This figure is a modification of FIG. 5 and uses the same reference numerals of the preceding figures. As in FIG. 5, the upper opening 30 of the module housing 12 is covered with a covering unit 76, which in this embodiment has the form of a lid, which is affixed onto the housing 12 preferably by some kind of a snapping mechanism. Furthermore, wire 72 with the wire end 74 is depicted, which is inserted into the right wire guidance channel system, the entrance of the wire not being shown. One difference is that wire end 74 is connected to a plug 201, the details of which are not shown. This wire is connected to the plug by known techniques such as crimping, soldering or using insulation displacement techniques. Plug 201 is provided with either receptacles or pins that are chosen so that the entire plug can be placed onto the counterpart of the active or passive component that is supposed to be inserted into the module housing 12. These receptacles or pins can be either arranged at the lateral side 202 so that upon the adaptation of the plug 201 onto the passive or active component the corresponding pins or receptacles of the component are generally perpendicular to the direction of the wire end 74, thus forming an angle of about 90 degrees. Alternatively, the receptacles or pins can be placed at the distal end 203 of plug 201, depending on the intended use of the plug.

Furthermore, wire 72 with wire end 74 and plug 201 as shown can be considered as a cross-sectional view, which means that wire 72 with wire end 74 could also represent two or more wires arranged in parallel, where these wires are then connected to a single plug having two or more positions.

Plugs of this kind are used whenever this appears to be advantageous with respect to the passive or active component to be inserted into module housing 12. The use of additional plugs 201 being either individual plugs or plugs with several wires leads to defined positions of the wires. Therefore, in this case additional provisions for the fixation of the wires are not necessarily required.

FIG. 12 is comparable to FIG. 11 with the basic difference that a different covering unit is used. The configuration shown is a modification from FIG. 9 utilizing the same reference numerals from the preceding figures. Only the upper portion of the housing module 12 is shown. In this case, the upper opening 30 is covered with a covering unit 88, which consists of a main cover plate 90 onto which a wiring plate 98 is attached, which essentially projects into the upper opening 30. As in FIG. 11, wire 72 with wire end 74 is inserted into the right wire guidance channel system. It passes through wiring plate 98 through opening 204 and is guided to the affixing device 112, which is comparable to the one in FIG. 9. The opening 204 differs from the holes 106 in FIG. 9 so far as it preferably has the form of a lateral slot, so that the wire can be placed into it even with a plug 201 fixed to it. Wire end 74 is then identical to the configuration in FIG. 11 connected to a plug 201. Also in this case, receptacles or pins can be either arranged on the lateral side 202 or at the distal end 203. Likewise, wire 72 with wire end 74 and plug 201 can also be considered as a cross-sectional view, which means that they may consist of two or more wires, so that plug 201 may be connected to two or more wire ends.

It should be noted that the examples shown here do not limit the invention. The multiplicity of alternative embodiments can be thought of, following the same principles as indicated.

1. A device for the covering of the position for a module in a modular distribution frame having a frame body, whereby the module can be arranged side-by-side with other modules on the frame body, the module further allowing to introduce wires with wire-ends that are intended to be connected to the module
characterized in that
the device comprises a covering unit that can be placed onto the position for the module, the covering unit providing protection to the wires and the wire-ends and maintaining defined positions of the wires.

2. A device for the covering of the position for a module according to claim 1,
characterized in that
the module comprises a housing into which a passive or active component can be introduced.

3. A device for the covering of the position for a module according to claim 2,
characterized in that
the housing comprises a wire guidance system in the form of channels.

4. A device for the covering of the position for a module according to claim 2,
characterized in that
the covering unit comprises devices for the positioning and fixing of the wires and the wire-ends.

5. A device for the covering of the position for a module according to claim 4,
characterized in that
the covering unit comprises a plate that projects into the module housing when placing the covering unit onto the position for the module, the plate containing the devices for the positioning and fixing of the wires and wire-ends.

6. A device for the covering of the position for a module according to claims 2 or 3
characterized in that
the covering unit has the form of a lid to be placed onto the module housing.

7. A device for the covering of the position for a module according to claim 1,
characterized in that
the covering unit can be directly placed onto the frame body of the modular distribution frame.

8. A device for the covering of the position for a module according to any one of the preceding claims,
characterized in that
the covering unit is provided with a snapping device.

9. A device for the covering of the position for a module according to any one of the preceding claims
characterized in that
the side of the covering unit that faces away from the modular distribution frame is provided with a system for the identification of the wires.

10. A device for the covering of the position for a module according to any one of the preceding claims,
characterized in that
one or more of the wire ends are connected to a plug.

11. A device for the covering of the position for a module according to any one of the preceding claims,
characterized in that
the passive or active component comprises an XDSL splitter.

12. Method for the generation of a module position in a telecommunication modular distribution frame, the position being intended to be retrofit with a passive or active component, characterized in that the method comprises the steps of
arranging a multiplicity of modules with housings on the frame-body of a modular distribution frame, the housings allowing to introduce wires having wire-ends that are intended to be connected to the passive or active component to be introduced into the modules,
into at least one of the module housings inserting a multiplicity of wires with wire-ends that are intended to be connected to the passive or active component to be introduced into the module,
arranging of the wire-ends within the modules in pre-defined positions allowing the maintenance of defined positioning of the wires and their connection to the passive or active component.

13. Method for the generation of a module position in a telecommunication modular distribution frame according to claim 12 characterized in that the method comprises the further step of placing a covering unit onto the module.

14. Method for the generation of a module position in a telecommunication modular distribution frame according to claim 13,
characterized in that
the wire ends are fixed to the covering unit.

15. Method for the generation of a module position in a telecommunication modular distribution frame according to claim 13,
characterized in that
at least one of the wire ends is connected to a plug.
